(19) United States
(12) Patent Application Publication
(10) Pub. No.: US 2004/0146673 A1
(43) Pub. Date: Jul. 29, 2004

(54) Container preform assembly and method of manufacture

(76) Inventor: W. Bruce Larsen, Holland, OH (US)

Correspondence Address: OWENS-ILLINOIS, INC., ONE SEAGATE, 25-LDP, TOLEDO, OH, 43666, US

(21) Appl. No.: 10/351,671

(22) Filed: Jan. 24, 2003

(51) Int. Cl. B65D 1/00; F16L 1/00; B23P 11/02

(52) U.S. Cl. 428/35.7; 29/453

(57) ABSTRACT

A method of making a preform assembly includes providing an integrally molded preform having a neck with an external surface, an external flange at one end of the neck and a preform body at an opposing end of the neck. The flange and the body both have outside diameters that are greater than the outside diameter of the external surface of the neck. A split annular molded plastic finish ring is assembled to the preform by expanding the ring, moving the ring to a position encircling the neck, and then closing the ring around the neck. In one presently preferred embodiment of the invention, the split annular finish ring is of resilient construction. The ring is resiliently expanded and assembled to the preform by moving the ring over the body or the flange to a position encircling the neck, and then releasing the ring so that the ring resiliently contracts around the neck and engages the outer surface of the neck. In other embodiments of the invention, the split annular ring is provided with a hinge at which the ring may be expanded and contracted with respect to the preform neck, or the ring is provided in multiple pieces that are assembled around the neck of the preform.

The present invention is directed to preforms for blow molding plastic containers, and to methods of making such preforms.

### BACKGROUND AND SUMMARY OF THE INVENTION

In the manufacture of plastic containers, it is conventional to injection mold or compression mold a container preform having a body and a finish with one or more external threads. The finish typically is molded to its final geometry, while the body of the preform is subsequently blow molded to the desired geometry of the container body. The preform may be of monolayer construction, or may be of multilayer construction in which one or more intermediate layers in the preform body may or may not extend into the finish area of the preform. U.S. Pat. Nos. 4,609,516, 4,710,118 and 4,954,376 illustrate injection molding of multilayer container preforms.

Molding the finish portion of the container as part of the preform presents a number of problems. For example, when the preforms are formed by injection molding, the plastic material typically is injected into a mold cavity at the closed end of the preform body, so that the material must flow along the sides of the preform cavity into the area in which the finish is molded. The finish typically requires more accurate and stable dimensioning than the body of the preform, which may limit the cycle time of the molding process. Furthermore, the finish portion of the preform is of the same material as at least the outer layers of the preform body, which limits the ability to obtain the most desirable characteristics at the finish. When the preform is of polyester construction, such as polyethylene terephthalate (PET), the finish portion of the preform can be wholly or partially crystallized to improve the operating characteristics of the finish area, particularly in hot-fill container applications. However, the requirement that the finish be of the same material as at least the outer layers of the preform body still limits the design capabilities of preform manufacture.

A method of making a preform assembly in accordance with one aspect of the present invention includes providing an integrally molded preform having a neck with an external surface, an external flange at one end of the neck and a preform body at an opposing end of the neck. The flange and the body both have outside diameters that are greater than the outside diameter of the external surface of the neck. A split annular molded plastic finish ring is assembled to the preform by expanding the ring, moving the ring to a position encircling the neck, and then closing the ring around the neck. In one presently preferred embodiment of the invention, the split annular finish ring is of resilient construction. The ring is resiliently expanded and assembled to the preform by moving the ring over the body or the flange to a position encircling the neck, and then releasing the ring so that the ring resiliently contracts around the neck and engages the outer surface of the neck. In other embodiments of the invention, the split annular ring is provided with a hinge at which the ring may be expanded and contracted with respect to the preform neck, or the ring is provided in multiple pieces that are assembled around the neck of the preform.

### BRIEF DESCRIPTION OF THE DRAWINGS

The invention, together with additional objects, features, advantages and aspects thereof, will be best understood from the following description, the appended claims and the accompanying drawings, in which:

FIG. 1 is a front perspective view of a preform assembly in accordance with one presently preferred embodiment of the invention;

FIG. 2 is an exploded perspective view of the preform assembly illustrated in FIG. 1;

FIG. 3 is a top plan view of the finish ring in the preform assembly of FIGS. 1 and 2.

FIG. 4 is a perspective view of a preform assembly at an intermediate stage of assembly in accordance with a second presently preferred embodiment of the invention;

FIG. 5 is a top plan view of the finish ring in the assembly of FIG. 4;

FIG. 6 is an exploded fragmentary perspective view of a preform assembly in accordance with a third presently preferred embodiment of the invention; and

FIG. 7 is a fragmentary perspective view that illustrates the lap joints at the ends of the finish ring segments in the embodiment of FIG. 6.

### DETAILED DESCRIPTION OF PREFERRED EMBODIMENTS

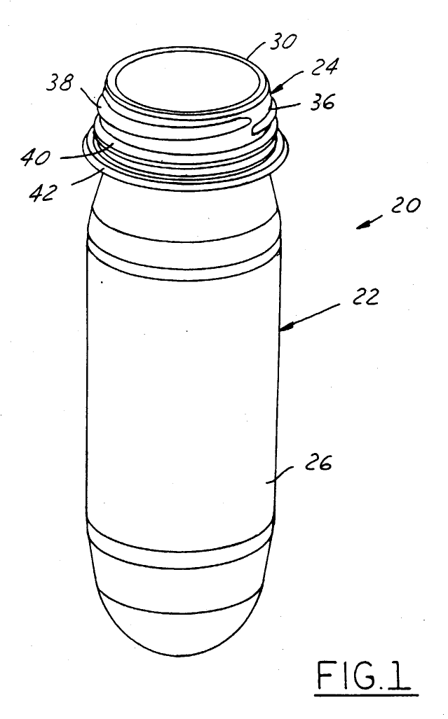

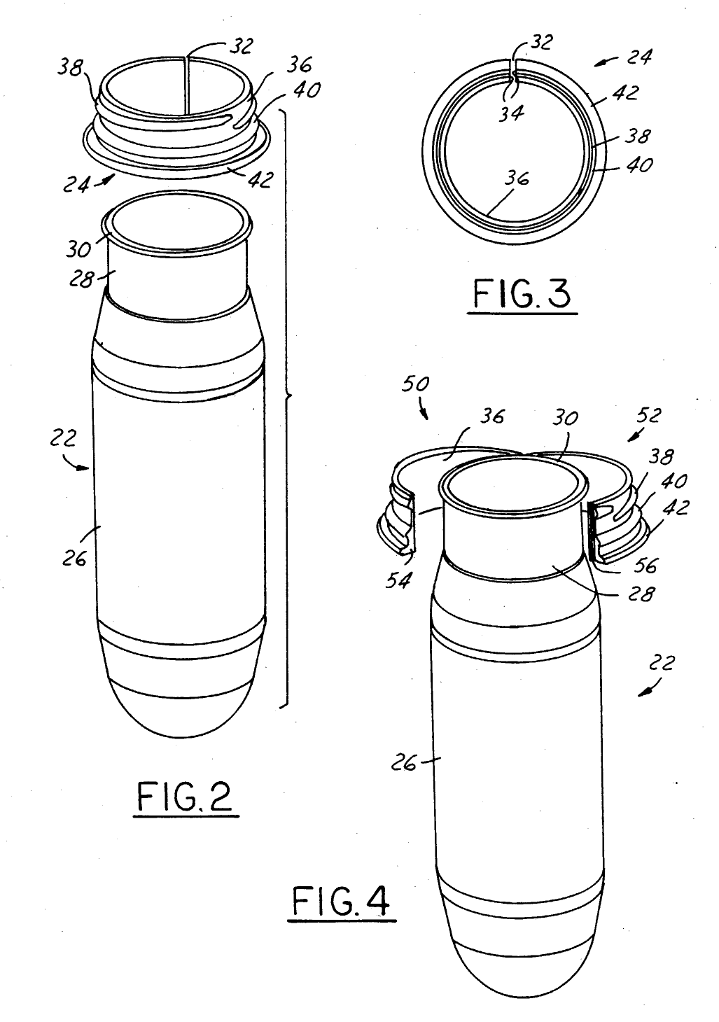

FIGS. 1-3 illustrate a preform assembly 20 in accordance with one presently preferred embodiment of the invention as comprising a preform 22 having a finish ring 24 secured thereto. Preform 22 is of one-piece integrally molded plastic construction, and includes a body 26 having a closed lower end, a neck 28 extending from body 26 and a radially outwardly extending flange 30 at the end of neck 28 remote from body 26. (Directional words such as “upper” and “lower” are used by way of description and not limitation with respect to the upright orientation of the preform assemblies illustrated in the drawings. Directional words such as “radial” and “circumferential” are employed by way of description and not limitation with respect to the axis of the preform or finish ring as appropriate.) Neck 28, which typically is cylindrical, is coaxial with body 26 and flange 30. The exterior surface of neck 28 is at a lesser diameter than the exterior surface of both body 26 and flange 30.

Finish ring 24 in the embodiment of FIGS. 1-3 is a split annular ring having a single gap 32 formed by opposed ring ends 34. Ring 24 includes an annular cylindrical wall 36 having at least one external thread or thread segment 38 disposed on the outer surface of the wall. In the preferred embodiments, ring 24 also includes an external bead 40 for tamper indication, and a capping flange 42 that extends from one end of wall 36 and lends an overall L-shaped configuration to ring 24 when viewed in radial cross section. As an alternative, capping flange 42 can be molded on the preform neck. Ring 24 is assembled to preform 22 by expanding the circumference of ring 24—i.e., by enlarging gap 32 by moving ring ends 34 away from each other. The expanded ring may then be assembled to the preform by moving the ring over either flange 30 or preform body 26 until ring 24 externally encircles neck 28. A tapered mandrel or other expansion tool may be employed, if desired. When ring 24 encircles neck 28, the ring is released so that the resiliency of the ring causes the ring to contract around the outside surface of neck 28. The relaxed diameter of ring 24 preferably is such that ring 24 is held on neck 28 by interference fit. This interference fit may be supplemented, if desired, by use of adhesive or by ultrasonic welding. Suitable anti-rotation means may be provided on ring 24, and neck 28 or flange 30, if desired.

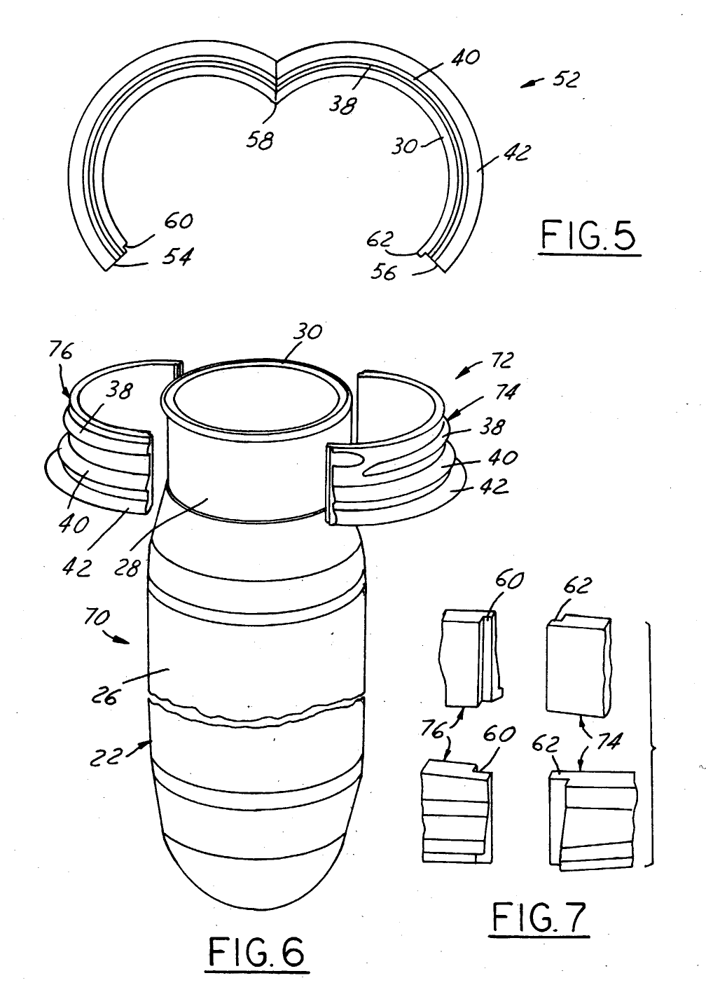

FIGS. 4 and 5 illustrate a preform assembly 50 in accordance with a second exemplary preferred embodiment of the invention. Reference numerals employed in FIGS. 4-5 (and in FIGS. 6-7) that are identical to those employed in connection with FIGS. 1-3 indicate correspondingly identical or related components. In preform assembly 50, a finish ring 52 is assembled to the outside surface of neck 28 of preform 22. Finish ring 52 is again of split annular construction, having a gap formed by circumferentially opposed ends 54, 56. A hinge 58 is molded into ring 52, preferably at a position diametrically spaced from ends 54, 56 when the ends are brought together. Thus, ring 52 may be opened to the configuration illustrated in FIGS. 4 and 5 with ends 54, 56 widely separated, and ring 52 can then be moved over neck 28 of preform 22 so as to encircle the outside surface of the neck. Ring 52 is then closed to bring ends 54, 56 into adjacent relationship to each other, either abutting relationship or closely spaced relationship. End 54 has a slot 60 that receives a tongue 62 on end 56 to form a lap end joint when the ring is closed. The ring may then be secured to neck 28 by adhesive, ultrasonic welding or other suitable means.

FIGS. 6 and 7 illustrate a third exemplary preferred preform assembly 70 in accordance with the present invention as comprising a preform 22 and a split annular ring 72. In this embodiment, ring 72 is comprised of separate part-annular segments 74, 76 that, when brought together, form an annular ring that tightly embraces and engages the outer surface of neck 28. Such engagement preferably is enhanced by adhesive, ultrasonic welding or other suitable means. The opposed ends of ring segments 74, 76 are provided with lap joints, as illustrated in FIG. 7.

Preforms 22 may be of any suitable plastic construction, such as monolayer PET or multilayer construction of PET layers alternating with layers of barrier resin such as ethylene vinyl alcohol (EVOH) or nylon. Preforms 22 may be injection molded or compression molded. Likewise, finish rings 24, 52, 72 may be of injection or compression molded plastic construction. By providing finish rings 24, 52, 72 separate from preform 22, the finish rings may be of any desired material construction, either the same as or more preferably different from the material construction of preform 22. For example, the finish rings can be of PET, post consumer resin (PCR), process regrind (REG), polypropylene (PP), polyethylene (PE) or polyethylene naphthalate (PEN) construction. Where the finish ring is of polyester construction (e.g., PET, PEN or polyester regrind), the finish ring may be wholly or partially crystallized as molded. This may be accomplished by employing fast-crystallizing materials or suitably setting process conditions for manufacture of the finish ring, such as high mold temperature, slow mold cooling, heated areas in the mold cavity, etc. The finish ring alternatively may be wholly or partially crystallized in a post-molding operation. In other words, the material and conditions of fabrication of the finish ring may be selected separately from the material and manufacturing conditions of preform 22 to achieve desired operating characteristics at the finish area of the preform and the final container. Furthermore, the preform can be molded with thin wall sections without having to accommodate flow of material into a thicker finish area, which reduces material cost and mold cycle time. The preform neck and/or the finish ring can be provided with suitable means for preventing rotation of the ring on the neck.

There have thus been disclosed a preform assembly and method of manufacture that fully satisfy all of the objects and aims previously set forth. The invention has been disclosed in conjunction with three presently preferred embodiments thereof, and a number of modifications and variations have been discussed. Other modifications and variations will readily suggest themselves to persons of ordinary skill in the art. The invention is intended to embrace all such modifications and variations as fall within the spirit and broad scope of the appended claims.

1. A method of making a preform assembly, which includes the steps of:
(a) providing an integrally molded preform that includes a neck with an external surface, an external flange at one end of said neck and a preform body at an opposing end of said neck, said flange and said body both having outside diameters that are greater than the outside diameter of said external surface,
(b) providing a split annular molded plastic finish ring, and
(c) assembling said ring to said preform by expanding said ring, moving said ring to a position encircling said neck, and then closing said ring around said neck.

2. The method set forth in claim 1 wherein said split annular ring is resiliently expanded in said step (c) and then released so as to contract and engage said exterior surface of said neck.

3. The method set forth in claim 1 wherein said split ring has a hinge, and is expanded in said step (c) and then contracted about said outer surface of said neck.

4. The method set forth in claim 1 wherein said ring has spaced splits that form a multiple-piece ring that is assembled around said neck in said step (c).

5. The method set forth in claim 1 wherein said finish ring has at least one external thread and an external capping flange at one axial end of said ring.

6. The method set forth in claim 1 wherein said plastic finish ring is of a different material construction from said plastic preform.

7. The method set forth in claim 1 wherein said plastic finish ring is of a material construction selected from the group consisting of: PET, PP, PE, PEN, REG, PCR, and wholly or partially crystallized polyester.

8. A method of making a preform assembly, which includes the steps of:
(a) providing an integrally molded preform that includes a neck with an external surface, an external flange at one end of said neck and a preform body at an opposing end of said neck, said flange and said body both having outside diameters that are greater than the outside diameter of said external surface,
(b) providing a molded plastic finish ring of resilient annular construction having a split formed by opposed ring ends,
(c) resiliently expanding said ring so that said ends move away from each other, and
(d) assembling said expanded ring to said preform by moving said ring over said body or said flange to a position encircling said neck, and then releasing said ring so that said ring resiliently contracts around said neck and engages said outer surface of said neck.

9. The method set forth in claim 8 wherein said ends of said ring form a lap joint.

10. The method set forth in claim 8 wherein said plastic finish ring is of a different material construction from said plastic preform.

11. The method set forth in claim 8 wherein said plastic finish ring is of a material construction selected from the group consisting of: PET, PP, PE, PEN, REG, PCR, and wholly or partially crystallized polyester.

12. A preform assembly for blow molding a container, which includes:
an integrally molded plastic preform having an open mouth, a neck surrounding said mouth with an external surface at a first diameter, an external flange at one end of said neck surrounding said mouth, and a preform body at an end of said neck spaced from said flange, said body and said flange both having external diameters greater than said first diameter, and
a split annular molded plastic finish ring externally mounted on said external surface of said neck.

13. The preform assembly set forth in claim 12 wherein said split annular ring is a one-piece ring.

14. The preform assembly set forth in claim 12 wherein said split annular ring is a multiple-piece ring.

15. The preform assembly set forth in claim 12 wherein said plastic finish ring is of a different material construction from said plastic preform.

16. The preform assembly set forth in claim 12 wherein said plastic finish ring is of a material construction selected from the group consisting of: PET, PP, PE, PEN, REG, PCR, and wholly or partially crystallized polyester.
